(19) United States
(12) Patent Application Publication
(10) Pub. No.: US 2008/0272644 A1
(43) Pub. Date: Nov. 6, 2008

(54) Vehicle wheel and related method of manufacture

(75) Inventor: Sheryar Durrani, West Bloomfield, MI (US)

Correspondence Address: HARNESS, DICKEY & PIERCE, P.L.C., P.O. BOX 828, BLOOMFIELD HILLS, MI, 48303, US

(73) Assignee: DURRANI RACING COMPONENTS, Farmington Hills, MI (US)

(21) Appl. No.: 12/150,886

(22) Filed: May 1, 2008

Related U.S. Application Data
(60) Provisional application No. 60/915,486, filed on May 2, 2007.

(51) Int. Cl. B60B 1/00; B22D 17/00

(52) U.S. Cl. 301/55; 164/113

(57) ABSTRACT

A vehicle wheel includes a hub, a plurality of spokes and a rim. The plurality of spokes radially extend from the hub. The rim is carried at outer ends of the plurality of spokes and circumscribe the wheel. At least the plurality of spokes is injection molded of a magnesium alloy.

### CROSS-REFERENCE TO RELATED APPLICATIONS

This application claims priority to U.S. Provisional Patent Application No. 60/915,486 filed 2 May 2007, which application is herein expressly incorporated by reference.

### FIELD

The present disclosure relates to vehicle wheels. The present disclosure additionally relates to a method of manufacturing a vehicle wheel.

### SUMMARY

In accordance with one particular aspect, the present teachings provide a vehicle wheel including a hub, a plurality of spokes, and a rim. The spokes of the plurality of spokes radially extend from the hub. The rim is carried proximate outer ends of the plurality of spokes and circumscribes the wheel. The spokes of the plurality of spokes may be injection molded of a magnesium alloy.

In accordance with another particular aspect, the present teachings provide a motorcycle wheel including a hub, a plurality of spokes, a hub and at least one hub plate. The spokes of the plurality of spokes radially extend from the hub. The rim is carried proximate outer ends of the plurality of spokes and circumscribes the wheel. The at least one hub plate and the hub may include cooperating threads for attachment of the at least one hub plate to the hub.

In accordance with another particular aspect, the present teachings provide a method of manufacturing a motorcycle wheel. The method includes injection molding at least a plurality of spokes of a wheel core from a magnesium alloy. The wheel core further includes a hub and a wheel hoop proximate outer ends of the plurality of spokes. The method further includes ring rolling a rim and securing the rim to the wheel core.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a front view of a vehicle wheel in accordance with the present teachings.

FIG. 2 side view of a vehicle wheel in accordance with the present teachings.

FIG. 3 is an exploded perspective view of a vehicle wheel in accordance with the present teachings.

FIG. 4 is an enlarged perspective view of a wheel core of a vehicle wheel in accordance with the present teachings.

FIG. 5 is a cross-sectional view of taken along the line 5-5 of FIG. 1.

FIG. 6 is a cross-sectional view of taken along the line 6-6 of FIG. 1.

FIG. 7 is a cross-sectional view of taken along the line 7-7 of FIG. 1.

FIG. 8 is a cross-sectional view of taken along the line 8-8 of FIG. 1.

FIG. 9 is a side view of another vehicle wheel in accordance with the present teachings.

FIGS. 10A through 10C are perspective views illustrating a cushion drive arrangement for a motorcycle wheel in accordance with the present teachings.

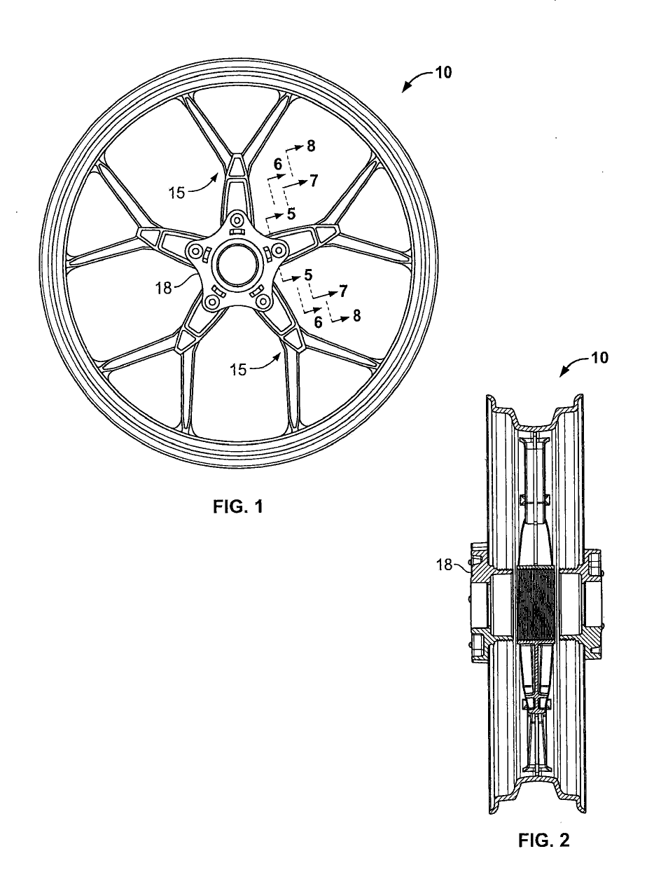

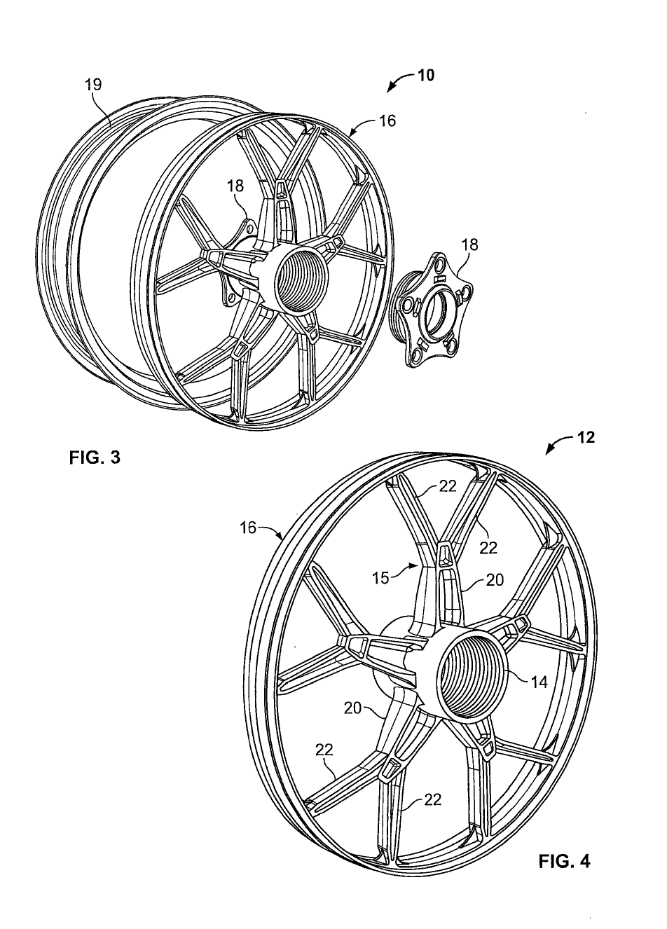

### DESCRIPTION OF VARIOUS ASPECTS

The following description is merely exemplary in nature and is not intended to limit the present disclosure, application, or uses.

With reference to the drawings, a vehicle wheel constructed in accordance with the present teachings is illustrated and identified at reference character 10. It will be understood that the particular wheels 10 shown in the drawings are merely exemplary wheels. In this regard, various other wheels are anticipated within the fair scope of the present teachings. In one particular application, the present teachings are directed to motorcycle wheels. Other types of wheels, including but not limited to wheels for passenger cars and airplanes, may be manufactured in accordance with the present teachings.

The wheel 10 may generally include a core or wheel core 12. The core 12 may include a hub 14 and a plurality of spokes 15 radially extending between the hub 14 and a wheel hoop 16. The wheel hoop 16 may be carried proximate the outer ends of the plurality of spokes 15 and may circumscribe the wheel core 12. The wheel 10 may further generally include a rim ring 19 secured to the wheel hoop 16.

The wheel 10 may additionally include one or more hub plates 18. As shown in the drawings, the one or more hub plates 18 may include a pair of hub plates 18. The hub plates 18 may be interchangeably interconnected to the wheel core 12. The hub and hub plates 14 and 18 may be formed to include cooperating threads. For example, the hub 14 may be internally threaded and may engage external threads of the hub plates 18.

The hub plates 18 shown in the drawings have a particular hole pattern to receive mounting bolts. Alternate hub plates 18 may include a greater or lesser number of holes and/or holes in different positions. In this manner, a common wheel 10 may be quickly and easily adopted for different uses (e.g., different motorcycles), thereby reducing tooling and inventory.

The hub 14 may be integrally formed with the remainder of the wheel core 12 in any manner well known in the art. The hub 14 may be threaded and bonded and/or welded to the remainder of the wheel core 12, for example. Within the scope of the present teachings, the hub 14 may be secured in any manner known in the art.

In certain applications, the spokes 15 may have a cross-sectional area that decreases as the spokes extend from the hub 14 to the wheel core 16. As shown, the spokes 15 may include an inner spoke portion 20 and outer spoke portions 22. Each inner spoke portion 20 may be associated with first and second outer spoke portions 22. The spokes 15 may be injection molded of a magnesium alloy. For certain applications, the spokes 15 may be injection molded of AM60B magnesium alloy. The wheel core 16 may be integrally formed with the plurality of spokes 15. The spokes 15 and wheel core 16 may be thixomolded. Other materials may be alternatively used.

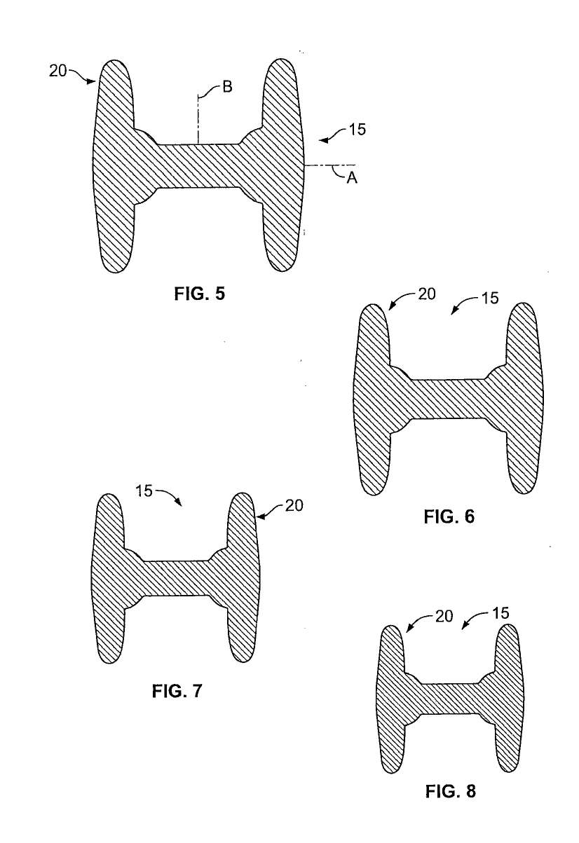

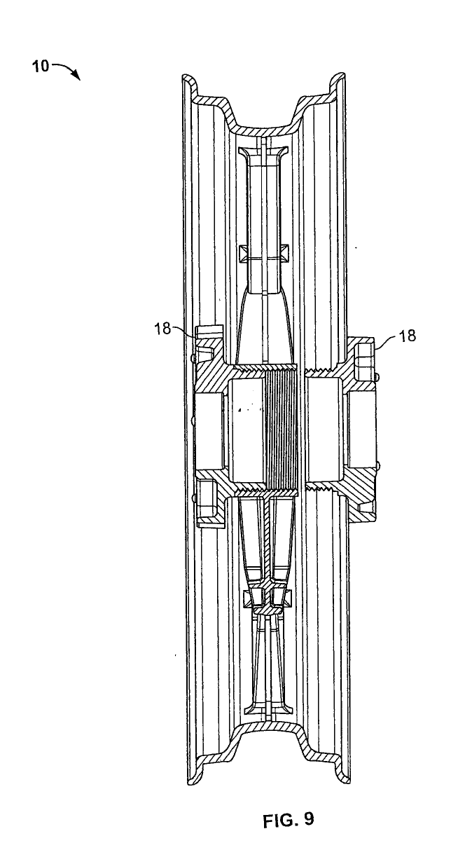

As shown in the cross-sectional views of FIGS. 5 through 8, at least a portion of the spokes 15 may include cross-sectional area that decreases as the spokes extend from the hub 14 to the hoop 16. In this regard, the inner portions 20 of the spokes 15 may include a cross-sectional area that decreases. The cross section of the inner portions 20 may be generally H-shaped and be generally symmetric about midlines A and B (see FIG. 5). Other shapes may be used within the scope of the present teachings. The outer portions 22 of the spokes 15 may similarly decrease in cross-sectional area as the spokes 15 progress toward the hoop 16.

The rim ring 19 may be an extrusion. The rim ring 19 may be ring rolled and laser welded together at a butt joint, for example. The rim ring 19 may be laser welded and/or bonded to the wheel core 16. The extruded rim ring may be drilled or milled and pinned to itself with similar or dissimilar material pins and optionally to the wheel core 16 for alignment. While other materials may be employed, the rim ring 19 may be extruded from a magnesium alloy. In certain applications, the rim ring 19 may be extruded from AZ80A magnesium alloy.

As shown in FIG. 8, the hub 14 may be an offset hub 14. The offset hub 14 may be formed by heating the wheel core 16 and stroking the hub 14 with a press such as an arbor press. The hub 14 may be repositioned in this manner to accommodate an asymmetric application for the wheel 10.

A wheel constructed in accordance with the present teachings may be constructed in one, two, three, four or more pieces. The one-piece wheel 10 may be a single, solid thixomolded wheel that integrates the wheel core, hub plates, and rim ring as a single piece. The two-piece wheel may include two halves. For example, the halves may be symmetric about a centerline plane of the wheel (e.g., perpendicular to the axis of rotation) creating a hollow cavity in the spokes such that the two halves are bonded and/or welded (e.g., laser welded) together to form a complete wheel.

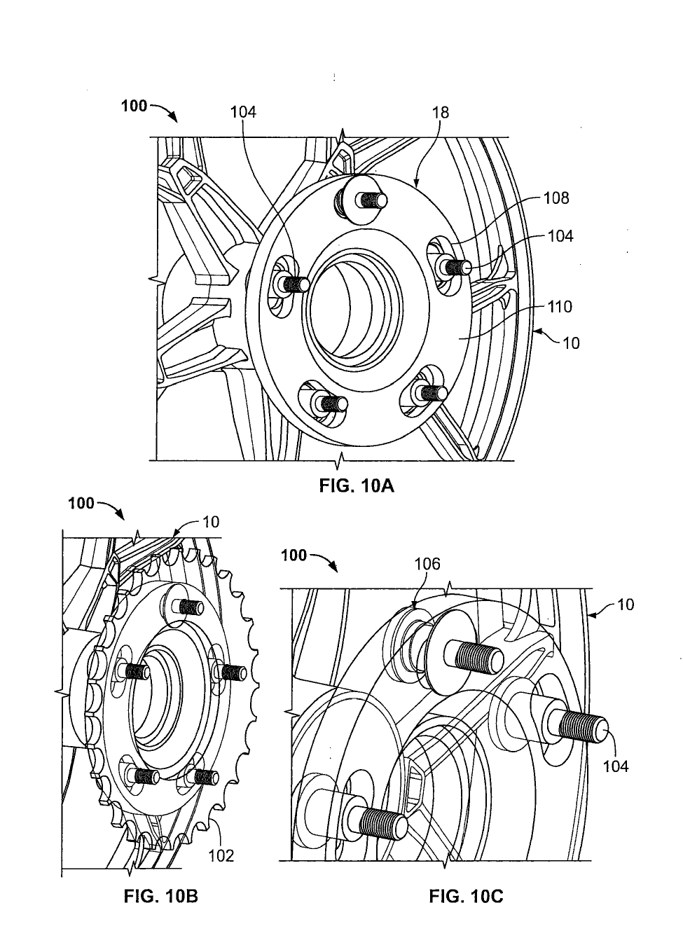

Turning to FIGS. 10A-10C, a cushion drive arrangement for a motorcycle wheel in accordance with the present teachings is illustrated and generally identified at reference character 100. The cushion drive arrangement 100 may be used with various types of wheels. For purposes of illustration, the cushion drive arrangement 100 is illustrated in FIGS. 10A-10C operatively associated with the wheel 10 described herein.

The cushion drive arrangement 100 may operate to dampen engine pulses otherwise delivered to the wheel 10. In conventional arrangements, such engine pulses may adversely affect vehicle performance. Under extreme conditions, such engine pulses may fracture the motorcycle chain.

This cushion drive arrangement 100 may utilize a sprocket 102 as its own load path to transmit power through a plurality of shoulder bolts 104. As illustrated, the power is transmitted through five shoulder bolts 104. Alternatively, a greater or lesser number of bolts 104 may be used. The arrangement 100 may further include bushings 106. The bushings may allow the shoulder bolts 104 to move freely in a circular motion. The bushings may be bronze or nylon/acetyl material bushings 104 or bushings of any other suitable material known in the art.

While specific examples have been described in the specification and illustrated in the drawings, it will be understood by those skilled in the art that various changes may be made and equivalence may be substituted for elements thereof without departing from the scope of the present teachings as defined in the claims. Furthermore, the mixing and matching of features, elements and/or functions between various examples may be expressly contemplated herein so that one skilled in the art would appreciate from the present teachings that features, elements and/or functions of one example may be incorporated into another example as appropriate, unless described otherwise above. Moreover, many modifications may be made to adapt a particular situation or material to the present teachings without departing from the essential scope thereof.

Therefore, it may be intended that the present teachings not be limited to the particular examples illustrated by the drawings and described in the specification as the best mode of presently contemplated for carrying out the present teachings but that the scope of the present disclosure will include any embodiments following within the foregoing description and any appended claims.

1. A vehicle wheel comprising:
a hub;
a plurality of spokes radially extending from the hub; and
a rim carried at outer ends of the plurality of spokes and circumscribing the wheel;
wherein at least the plurality of spokes is injection molded of a magnesium alloy.

2. The vehicle wheel of claim 1, wherein the wheel is a motorcycle wheel.

3. The motorcycle wheel of claim 1, wherein the plurality of spokes are constructed of a first magnesium alloy and the rim is constructed of a second, magnesium alloy, the first magnesium alloy being different than the second magnesium alloy.

4. The motorcycle wheel of claim 2, wherein the plurality of spokes are injection molded of AM60B magnesium alloy.

5. The motorcycle wheel of claim 4, wherein the rim is constructed of AZ80A magnesium alloy.

6. The motorcycle wheel of claim 2, wherein at least one of the spokes of the plurality of spokes has a cross-sectional area that decreases as the spoke extends radially from the hub.

7. The motorcycle wheel of claim 2, further comprising at least one hub plate threadably interconnected to the hub.

8. The motorcycle wheel of claim 8, wherein the hub is internally threaded and engages external threads of the at least one hub plate.

9. The motorcycle wheel of claim 2, wherein the spokes of the wheel are thixomolded.

10. The motorcycle wheel of claim 2, further comprising a wheel core, the wheel core including a wheel hoop, the plurality of spokes and the hub, the rim secured to the wheel hoop.

11. The motorcycle wheel of claim 10, wherein the rim is ring rolled and laser welded together at a butt joint.

12. The motorcycle wheel of claim 11, wherein the rim is secured to the wheel hoop with one of laser welding or bonding.

13. The motorcycle wheel of claim 10, wherein the rim is drilled or milled and pinned to itself with similar or dissimilar material pins and optionally to the wheel core for alignment.

14. The motorcycle wheel of claim 2, wherein the hub is an offset hub.

15. A motorcycle wheel comprising:
a hub;
a plurality of spokes radially extending from the hub;
a rim carried proximate outer ends of the plurality of spokes and circumscribing the wheel; and
at least one hub plate;
wherein the hub and the at least one hub plate include cooperating threads for attachment of the at least one hub plate to the hub.

16. The motorcycle wheel of claim 15, wherein the hub is internally threaded for engaging the at least one hub plate.

17. The motorcycle wheel of claim 15, wherein the at least one hub plate includes a plurality of interchangeable hub plates.

18. A method of manufacturing a motorcycle wheel comprising:
injection molding at least a plurality of spokes of a wheel core from a magnesium alloy, the wheel core further including a hub and a wheel hoop carried proximate outer ends of the plurality of spokes;
ring rolling a rim; and
securing the rim to the wheel core.

19. The method of manufacturing a motorcycle wheel of claim 18, wherein at least some of the spokes are injection molded to include a cross-sectional area that decreases as the spokes radially extend from the hub.

20. The method of manufacturing a motorcycle wheel of claim 18, wherein the plurality of spokes are constructed of a first magnesium alloy and the rim is constructed of a second, magnesium alloy, the first magnesium alloy being different than the second magnesium alloy.

21.-31. (canceled)
